(19) United States
(12) Patent Application Publication
(10) Pub. No.: US 2018/0196616 A1
(43) Pub. Date: Jul. 12, 2018

(54) MEMORY DEVICE AND MEMORY MODULE

(71) Applicant: SK hynix Inc., Icheon-si Gyeonggi-do (KR)

(72) Inventor: Young Choul CHO, Icheon-si Gyeonggi-do (KR)

(73) Assignee: SK hynix Inc., Icheon-si Gyeonggi-do (KR)

(21) Appl. No.: 15/648,624

(22) Filed: Jul. 13, 2017

(30) Foreign Application Priority Data
Jan. 12, 2017 (KR) 10-2017-0004964

(51) Int. Cl. G06F 3/06

(52) U.S. Cl. CPC G06F 3/0619; G06F 3/0659; G06F 3/067; G06F 3/065

(57) ABSTRACT

A memory device may be provided. The memory device may include a plurality of memory banks, an at least one spare bank. The memory device may include a correcting and defending logic circuit. The memory device may include a bank gating circuit. The correcting and defending logic circuit may generate a backup command signal and a gating control signal based on any one of a host correction request and a memory defense request. The bank gating circuit may be coupled to the plurality of memory banks and the spare bank based on the gating control signal.

### CROSS-REFERENCES TO RELATED APPLICATION

The present application claims priority under 35 U.S.C. § 119(a) to Korean application number 10-2017-0004964, filed on Jan. 12, 2017, in the Korean Intellectual Property Office, which is incorporated herein by reference in its entirety.

### BACKGROUND

### 1. Technical Field

Various embodiments may generally relate to a semiconductor technology, and more particularly, to a memory device and a memory module.

### 2. Related Art

An electronic device may include a number of electronic components, and a large part of the electronic components may be implemented with a semiconductor system. Among semiconductor devices constituting a computer system, a host such as a processor or memory controller may communicate with a memory device. During the communication between the host and the memory device, an error may occur in the memory apparatus due to an unexpected reason. The host can correct the error through a software or hardware access. At this time, the system needs to stop all normal operations which were being performed, and correct the error by changing the basic input and output system (BIOS). Then, the system needs to be rebooted.

### SUMMARY

In an embodiment, a memory device may be provided. The memory device may include a plurality of memory banks, an at least one spare bank. The memory device may include a correcting and defending logic circuit. The memory device may include a bank gating circuit. The correcting and defending logic circuit may generate a backup command signal and a gating control signal based on any one of a host correction request and a memory defense request. The bank gating circuit may be coupled to the plurality of memory banks and the spare bank based on the gating control signal.

In an embodiment, a memory module may be provided. The memory module may include a plurality of memory devices. The memory module may include a correcting and defending logic circuit configured to generate a gating control signal and a backup command signal based on any one of a host correction request and a memory defense request. Each of the memory devices may include a plurality of memory banks and at least one spare bank. Each of the memory devices may include a bank gating circuit coupled to the plurality of memory banks and the at least one of spare bank based on the gating control signal.

In an embodiment, a memory device may be provided. The memory device may include a plurality of memory banks and at least one spare bank. The memory device may include a correcting and defending logic circuit configured to generate a backup command signal to copy data stored in a memory bank having an error therein into a spare bank from the at least one spare bank, and to copy data stored in a memory bank corresponding to a target of a memory defense request into a spare bank from the at least one spare bank.

### BRIEF DESCRIPTION OF THE DRAWINGS

FIG. 1 is a diagram illustrating a configuration of a memory system including a memory device in accordance with an embodiment.

FIG. 2 is a diagram illustrating a configuration of the memory system including a memory module in accordance with a present embodiment.

FIG. 3 is a diagram illustrating a configuration of a system in accordance with an embodiment.

FIG. 4 is a diagram illustrating a configuration of a system in accordance with an embodiment.

### DETAILED DESCRIPTION

Hereinafter, a memory device and a memory module will be described below with reference to the accompanying drawings through various examples of embodiments.

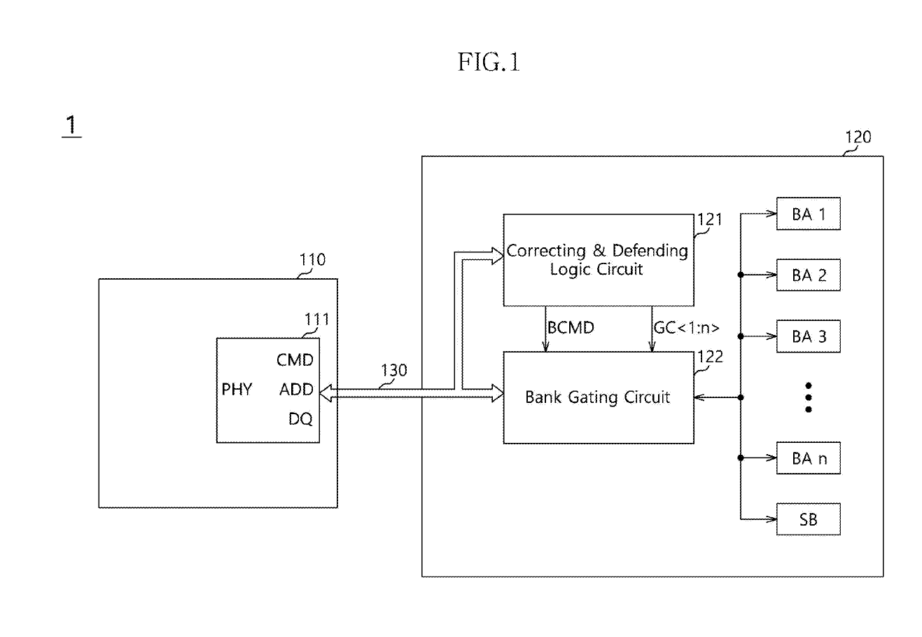

FIG. 1 is a diagram illustrating a configuration of a memory system 1 in accordance with an embodiment. Referring to FIG. 1, the memory system 1 may include a host 110 and a memory device 120. The host 110 may provide various control signals to the memory device 120 in order to control an operation of the memory device 120. For example, the host 110 may provide a command signal CMD, an address signal ADD, and data DQ to the memory device 120, such that the memory device 120 stores and outputs data. An operation of storing the data DQ transmitted from the host 110 in the memory device 120 may be referred to as a write operation, and an operation of outputting data stored in the memory device 120 to the host 110 may be referred to as a read operation. The host 110 may transmit the command signal CMD, the address signal ADD and the data DQ to the memory device through a plurality of buses 130. The host 110 may include an interface circuit (PHY) 111. The interface circuit 111 may transmit the command signal CMD, the address signal ADD, and the data DQ to the memory device 120 or receive the data DQ from the memory device 120. The host 110 may include, for example but not limited to, a Central Processing Unit (CPU), Graphic Processing Unit (GPU), Multi-Media Processor (MMP), digital signal processor and memory controller. Furthermore, processor chips such as Application Processor (AP), which have various functions, may be combined and implemented in the form of System On Chip (SOC).

The memory device 120 may receive the command signal CMD, the address signal ADD, and the data DQ from the host 110, and perform various operations. The memory device 120 may include a volatile memory and a nonvolatile memory. The volatile memory may include Static RAM (SRAM), Dynamic RAM (DRAM) and Synchronous DRAM (SDRAM), and the nonvolatile memory may include Read Only Memory (ROM), Programmable ROM (PROM), Electrically Erase and Programmable ROM (EEPROM), Electrically Programmable ROM (EPROM), Flash memory, Phase change RAM (PRAM), Magnetic RAM (MRAM), Resistive RAM (RRAM), Ferroelectric RAM (FRAM) and the like. The memory device 120 may include a plurality of memory banks BA1, BA2, BA3, . . . , BAn. Each of the memory banks BA1, BA2, BA3, . . . , BAn may include a plurality of memory cells to store data. The memory device 120 may include at least one spare bank SB. The spare bank SB may have substantially the same structure as the memory banks BA1, BA2, BA3, . . . , BAn.

The memory device 120 may perform a bank gating operation based on any one of a host correction request and a memory defense request. The memory device 120 may swap or interleave any one memory bank with the spare bank SB, the memory bank corresponding to the target of the host correction request or the memory defense request among the plurality of memory banks BA1, BA2, BA3, . . . , BAn. The host correction request may include error information sensed by the host 110. The memory defense request may include defense information sensed in the memory device 120.

The memory device 120 may include a correcting and defending logic circuit 121 and a bank gating circuit 122. The correcting and defending logic circuit 121 may generate a gating control signal GC<1:n> and a backup command signal BCMD based on any one of the host correction request and the memory defense request. The correcting and defending logic circuit 121 may receive the host correction request from the host 110. The correcting and defending logic circuit 121 may generate the gating control signal GC<1:n> for controlling the bank gating circuit 122 based on the host correction request. The host correction request may be transmitted as the command signal CMD to the correcting and defending logic circuit 121 of the memory device 120 from the host 110. The host correction request may include error information accumulated while the host 110 and the memory device 120 perform data communication. For example, when an error equal to or more than a threshold value occurs in any one memory bank among the plurality of memory banks BA1, BA2, BA3, . . . , BAn, the host 110 may generate the host correction request. For example, when an error which cannot be corrected through redundancy or error correction code (ECC) is present in any one memory bank, the host correction request may be generated. The correcting and defending logic circuit 121 may generate the gating control signal GC<1:n> based on the host correction request, such that the memory bank corresponding to the target of the host correction request can be swapped with the spare bank SB. The correcting and defending logic circuit 121 may generate the backup command signal BCMD to copy data stored in the memory bank having the error therein into the spare bank SB, and provide the backup command signal BCMD to the bank gating circuit 122. The backup command signal BCMD may include a backup read signal and a backup write signal.

The correcting and defending logic circuit 121 may generate the memory defense request. For example, the correcting and defending logic circuit 121 may monitor the address signal ADD, and generate the memory defense request based on the address signal ADD. In an embodiment, the correcting and defending logic circuit 121 may generate the memory defense request, in order to prevent row hammering. The correcting and defending logic circuit 121 may determine whether a specific address signal was consecutively inputted by the number of times equal to or more than a threshold value, and generate the memory defense request when the specific address signal was consecutively inputted by the number of times equal to or more than the threshold value. The correcting and defending logic circuit 121 may generate the gating control signal GC<1:n> based on the memory defense request, such that a memory bank corresponding to the target of the memory defense request mirrors the spare bank SB or is interleaved with the spare bank SB. Furthermore, the correcting and defending logic circuit 121 may generate the backup command signal BCMD based on the memory defense request, in order to copy the data stored in the memory bank corresponding to the target of the memory defense request into the spare bank SB.

The bank gating circuit 122 may receive the command signal CMD, the address signal ADD, and the data DQ from the host 110, and be coupled to the plurality of memory banks BA1, BA2, BA3, . . . , BAn and the spare bank SB. The bank gating circuit 122 may be coupled to the plurality of memory banks BA1, BA2, BA3, . . . , BAn and the spare bank SB based on the gating control circuit GC<1:n>. The bank gating circuit 122 may include a plurality of multiplexers capable of coupling the plurality of memory banks BA1, BA2, BA3, . . . , BAn to the spare bank SB, respectively. The bank gating circuit 122 may provide the command signal CMD, the address signal ADD, and the data DQ to the plurality of memory banks BA1, BA2, BA3, . . . , BAn and the spare bank SB, based on the gating control circuit GC<1:n>.

The operations of the memory device 120 and the memory system 1 in accordance with a present embodiment will be described as follows. First, when errors accumulated in a specific memory bank of the memory device 120 are equal to or more than a threshold value while the host 110 and the memory device 120 perform data communication, the host 110 may generate the host correction request and transmit the generated host correction request to the memory device 120. The host correction request may be transmitted to the memory device 120 when the memory device 120 does not perform an important operation, in order to interfere with another operation of the memory device 120. For example, the host 110 may transmit the host correction request to the memory device 120 when the memory device 120 performs a refresh operation. The memory device 120 may receive the host correction request containing information on a memory bank in which an error occurred. For example, suppose that the host correction request for the first memory bank BA1 was made. The correcting and defending logic circuit 121 may transfer and store data stored in the first memory bank BA1 into the spare bank SB. That is, the data stored in the first memory bank BA1 may be copied into the spare bank SB. The correcting and defending logic circuit 121 may generate the backup read signal and the gating control signal GC<1:n>, and the bank gating circuit 122 may provide the backup read signal to the first memory bank BA1, and output the data stored in the first memory bank BA1. Furthermore, the correcting and defending logic circuit 121 may generate the backup write signal and the gating control signal GC<1:n>, and the bank gating circuit 122 may provide the backup write signal to the spare bank SB, and store the data outputted from the first memory bank BA1 in the spare bank SB. When the copying of the data from the first memory bank BA1 into the spare bank SB is completed, the correcting and defending logic circuit 121 may transmit a completion signal to the host 110. Furthermore, the correcting and defending logic circuit 121 may generate the gating control signal GC<1:n> to couple the bank gating circuit 122 to the spare bank SB instead of the first memory bank BA1. The completion signal may be transmitted as the data DQ to the host 110 through the bus 130, for example. The host 110 may sense that the swapping operation of the memory bank has been completed, based on the completion signal, and transmit the command signal CMD, the address signal ADD and the data DQ to the memory device 120 in order to perform a normal operation on the first memory bank BA1. Since the bank gating circuit 122 is coupled to the spare bank SB instead of the first memory bank BA1 in the memory device 120, the bank gating circuit 122 may provide the command signal CMD, the address signal ADD, and the data DQ to the spare bank SB. The spare bank SB may read and write (read/write) data based on the command signal CMD, the address signal ADD, and the data DQ.

During the operation of the memory device 120, the correcting and defending logic circuit 121 may monitor whether row hammering occurs, based on the address signal ADD. When a specific address signal is consecutively inputted by the number of times equal to or more than a threshold value, the correcting and defending logic circuit 121 may determine that row hammering occurred, and generate the memory defense request. Hereafter, the specific address signal indicating the memory bank in which row hammering occurred may be referred to as a row hammering address signal. The memory defense request may contain information on the row hammering address signal and the memory bank in which row hammering occurred. For example, suppose that row hammering occurred in the second memory bank BA2. The correcting and defending logic circuit 121 may copy data stored in the second memory bank BA2 into the spare bank SB. The correcting and defending logic circuit 121 may generate the backup command signal BCMD and the gating control signal GC<1:n> to transfer and store the data stored in the second memory bank BA2 into the spare bank SB. When the row hammering address signal is inputted after the row hammering occurred, the correcting and defending logic circuit 121 may determine whether the command signal CMD received with the row hammering address signal is a write signal or read signal. When the command signal CMD is a write signal, the correcting and defending logic circuit 121 may generate the gating control signal GC<1:n> such that the bank gating circuit 122 is coupled to both of the second memory bank BA2 and the spare bank SB. Therefore, both of the second memory bank BA2 and the spare bank SB may store the data DQ transmitted from the host 110. In other words, the spare bank SB may mirror the second memory bank BA2. When the command signal CMD is a read signal, the correcting and defending logic circuit 121 may generate the gating control signal GC<1:n> such that the bank gating circuit 122 interleaves the second memory bank BA2 and the spare bank SB. That is, when the plurality of read operations are performed, the correcting and defending logic circuit 121 may generate the gating control signal GC<1:n> such that the second memory bank BA2 and the spare bank SB alternately perform the read operations. For example, the correcting and defending logic circuit 121 may control the bank gating circuit 122 to connect to the second memory bank BA2 when the first read signal is inputted, control the bank gating circuit 122 to connect to the spare bank SB when the second read signal is inputted, and control the bank gating circuit 122 to connect to the second memory bank BA2 when the third read signal is inputted. As such, when the memory defense request is generated, the correcting and defending logic circuit 121 can control the write operations to be performed on both the memory banks BA1, BA2, BA3, . . . , BAn and the spare bank SB, and control the read operations to be alternately performed on the memory banks BA1, BA2, BA3, . . . , BAn and the spare bank SB, thereby preventing a loss of the data stored in the memory device due to the row hammering.

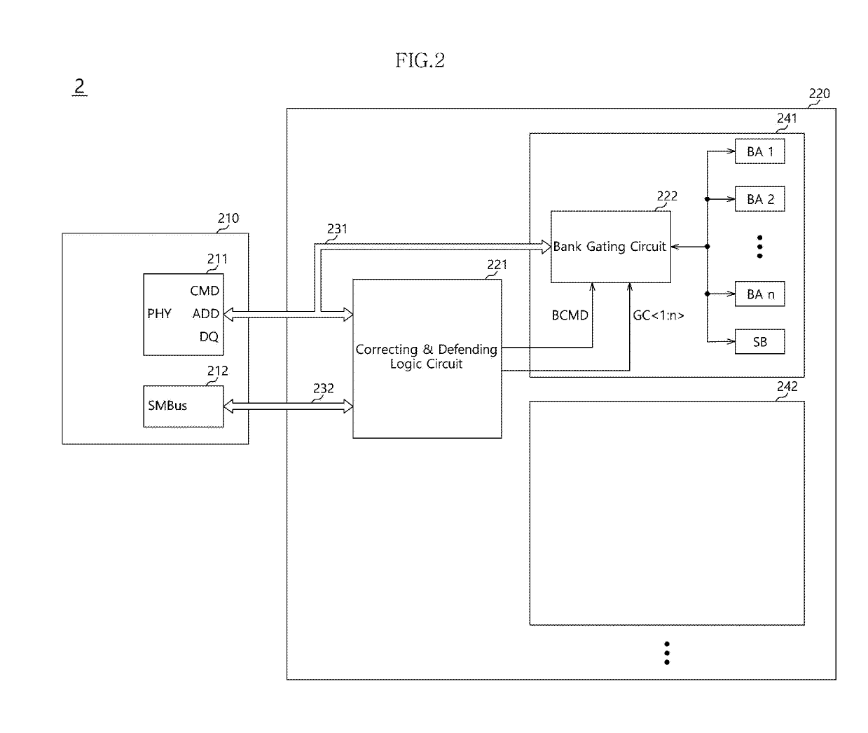

FIG. 2 is a diagram illustrating a configuration of a memory system 2 in accordance with an embodiment. The memory system 2 may include a host 210 and a memory module 220. The host 210 may transmit various control signals to the memory module 220, and perform data communication with the memory module 220. The host 210 may include an interface circuit (PHY) 211 configured to transmit a command signal CMD, an address signal ADD, and data DQ to the memory module 220 or receive the data DQ from the memory module 220. The interface circuit 211 may transmit the command signal CMD, the address signal ADD, and the data DQ to the memory module 220 from the host 210 or receive the data DQ from the memory module 220, through a plurality of buses 231.

The memory module 220 may include a plurality of memory devices 241 and 242 and a correcting and defending logic circuit 221. Each of the memory devices 241 and 242 may include a plurality of memory banks BA1, BA2, . . . , BAn, one or more spare banks SB and a bank gating circuit 222. FIG. 2 illustrates only the configuration of the first memory device 241, but the second memory device 242 may have substantially the same configuration as the first memory device 241. The correcting and defending logic circuit 221 may generate a gating control signal GC<1:n> and a backup command signal BCMD based on a host correction request and a memory defense request. The bank gating circuit 222 may be coupled to the plurality of memory banks BA1, BA2, BA3, . . . , BAn and the spare bank SB based on the gating control circuit GC<1:n>.

The correcting and defending logic circuit 221 may perform substantially the same function as the correcting and defending logic circuit 121 illustrated in FIG. 1. The correcting and defending logic circuit 121 may receive the host correction request from the host 210. The host 210 may include a system management circuit (SMBus) 212. The system management circuit 212 may transmit the host defense request as a system management bus protocol to the memory module 220 through the system management bus 232. The correcting and defending logic circuit 221 may monitor the address signal ADD transmitted from the host, and generate the memory defense request based on the address signal ADD.

The operations of the memory module 220 and the memory system 2 in accordance with a present embodiment will be described as follows. First, when errors accumulated in a specific memory bank of a specific memory device in the memory module 220 are equal to or more than a threshold value while the host 210 and the memory module 220 perform data communication, the host 210 may generate the host correction request and transmit the generated host correction request to the memory module 220. The memory module 220 may receive the host correction request containing information on the memory bank of the memory device in which the errors occurred. For example, suppose that the host correction request for the first memory bank BA1 of the first memory device 241 was made. The correcting and defending logic circuit 221 may generate the backup command signal BCMD and the gating control signal GC<1:n> to transfer and store the data stored in the first memory bank BA1 into the spare bank SB. When the copying of the data from the first memory bank BA1 into the spare bank SB is completed, the correcting and defending logic circuit 221 may transmit a completion signal to the host 210. The completion signal may be transmitted to the system management circuit 212 from the correcting and defending logic circuit 221 through the system management bus 232. Furthermore, the correcting and defending logic circuit 221 may generate the gating control signal GC<1:n> to couple the bank gating circuit 222 to the spare bank SB instead of the first memory bank BA1. The host 210 may sense that the swapping operation of the memory bank was completed, based on the completion signal, and transmit the command signal CMD, the address signal ADD, and the data DQ to the memory module 220 in order to perform a normal operation on the first memory bank BA1. Since the bank gating circuit 222 is coupled to the spare bank SB instead of the first memory bank BA1 in the memory device 241, the command signal CMD, the address signal ADD, and the data DQ may be provided to the spare bank SB. The spare bank SB may read/write data based on the command signal CMD, the address signal ADD, and the data DQ.

During the operation of the memory module 220, the correcting and defending logic circuit 221 may monitor whether row hammering occurs, based on the address signal ADD. For example, suppose that row hammering occurred in the second memory bank BA2 of the first memory device 241. The correcting and defending logic circuit 221 may generate the backup command signal BCMD and the gating control signal GC<1:n>, and transfer and store data stored in the second memory bank BA2 into the spare bank SB. When the row hammering address signal is inputted after the row hammering occurred, the correcting and defending logic circuit 221 may determine whether the command signal CMD received with the row hammering address signal is a write signal or read signal. When the command signal CMD is a write signal, the correcting and defending logic circuit 221 may generate the gating control signal GC<1:n> to couple the bank gating circuit 222 to both of the second memory bank BA2 and the spare bank SB. Therefore, both of the second memory bank BA2 and the spare bank SB may store the data DQ transmitted from the host 210. When the command signal CMD is a read signal, the correcting and defending logic circuit 221 may generate the gating control signal GC<1:n> such that the bank gating circuit 222 interleaves the second memory bank BA2 and the spare bank SB.

Although not illustrated, the memory module 220 may include a module controller or a module buffer such as advanced memory buffer. The module buffer may relay data communication between the host 210 and the memory devices 241 and 242 mounted in the memory module 220. The correcting and defending logic circuit 221 may be included in the module buffer, for example.

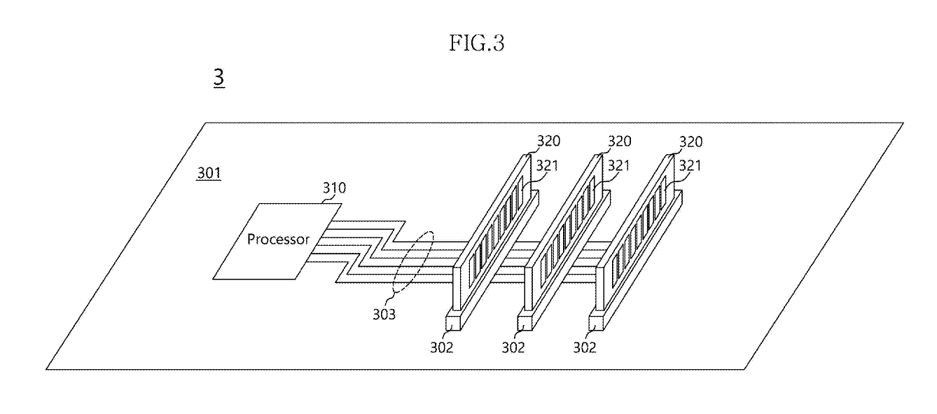

FIG. 3 is a diagram illustrating a configuration of a system 3 in accordance with an embodiment. The system 3 may include a main board 301, a processor 310, and a memory module 320. The main board 301 for mounting components constituting the system may also be referred to as a mother board. The main board 301 may include a slot (not illustrated) in which the processor 310 can be mounted and a slot 302 in which the memory module 320 can be mounted. The main board 301 may include wirings 303 for electrically connecting the processor 310 and the memory module 320. The processor 310 may be mounted on the main board 301.

The memory module 320 may be mounted on the main board 301 through the slot 302 of the main board 301. The memory module 320 may be coupled to the wirings of the main board 303 through the slot 302 and module pins formed on a module board. The memory module 320 may include Unbuffered Dual In-line Memory Module (UDIMM), Dual In-line Memory Module (DIMM), Registered Dual In-line Memory Module (RDIMM), Load Reduced Dual In-line Memory Module (LRDIMM), Small Outline Dual In-line Memory Module (SODIMM), Non-Volatile Dual In-line Memory Module (NVDIMM) and the like. The memory module 220 illustrated in FIG. 2 may be applied as the memory module 320. The memory module 320 may include a plurality of memory devices 321. Each of the memory devices 321 may include one or more of a volatile memory device and a nonvolatile memory device. The volatile memory device may include SRAM, DRAM and SDRAM, and the nonvolatile memory device may include ROM, PROM, EEPROM, EPROM, Flash memory, PRAM, MRAM, RRAM and FRAM. The memory device 321 may include a stacked memory device or multi-chip package having a plurality of chips stacked therein.

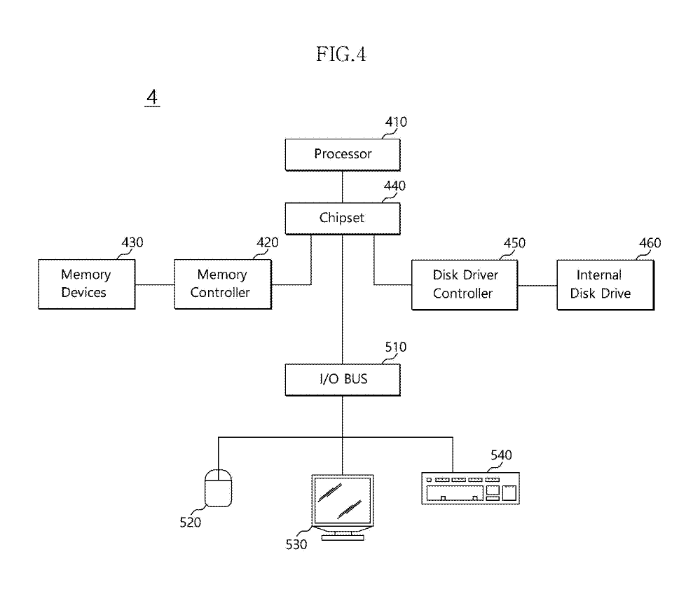

FIG. 4 is a diagram illustrating a configuration of a system 4 in accordance with an embodiment. Referring to FIG. 4, the system 4 may include a processor 410, a memory controller 420, and a memory device 430. The processor 410 may be coupled to the memory controller 420 through a chip set 440, and the memory controller 420 may be coupled to the memory device 430 through a plurality of buses. FIG. 4 illustrates one processor 410. However, the present embodiments are not limited thereto, but the system may include a plurality of physical or logical processors. The chip set 440 may provide a communication path through which a signal is transmitted between the processor 410 and the memory controller 420. The processor 410 may perform an arithmetic operation, and transmit a request and data to the memory controller 420 through the chip set 440 in order to input/output desired data.

The memory controller 420 may transmit a command signal, address signal, clock signal, and data through the plurality of buses. The memory device 430 may store data by receiving the signals from the memory controller 420, and output the stored data to the memory controller 420. The memory device 430 may include one or more memory devices or memory modules, and the memory device 120 of FIG. 1 or the memory module 220 of FIG. 2 may be employed as the memory device 430.

Referring to FIG. 4, the system 4 may further include an input/output (I/O) bus 510, an input/output device 520, 530 or 540, a disk driver controller 450 and an internal disk drive 460. The chip set 440 may be coupled to the input/output bus 510. The input/output bus 510 may provide a communication path for signal transmission from the chip set 440 to the input/output device 520, 530 or 540. The input/output device may include, for example but not limited to, a mouse 520, a video display 530 or a keyboard 540. The input/output bus 510 may include any communication protocols as long as the communication protocols can communicate with the input/output device 520, 530 or 540. The input/output bus 510 may be integrated in the chip set 440.

The disk driver controller 450 may be coupled to the chip set 440. The disk driver controller 450 may provide a communication path between the chip set 440 and one or more disk drives 460. The disk drive 460 may be utilized as an external data storage device for storing a command and data. The disk driver controller 450 and the disk drive 460 may communicate with each other or the chip set 440 through any communication protocols including the input/output bus 510.

While various embodiments have been described above, it will be understood to those skilled in the art that the embodiments described are examples only. Accordingly, the operating method of a data storage device described herein should not be limited based on the described embodiments.

What is claimed is:

1. A memory device comprising:
a plurality of memory banks;
at least one spare bank;
a correcting and defending logic circuit configured to generate a backup command signal and a gating control signal based on any one of a host correction request and a memory defense request; and
a bank gating circuit coupled to the plurality of memory banks and the at least one spare bank based on the gating control signal.

2. The memory device of claim 1, wherein the host correction request is transmitted as a command signal to the correcting and defending logic circuit.

3. The memory device of claim 1, wherein the correcting and defending logic circuit generates the memory defense request based on an address signal.

4. The memory device of claim 3, wherein the correcting and defending logic circuit generates the memory defense request when a specific address signal is consecutively inputted by the number of times equal to or more than a threshold value.

5. The memory device of claim 1, wherein the correcting and defending logic circuit generates the backup command signal and the gating control signal, and copies data stored in a memory bank into the spare bank, the memory bank corresponding to the target of the host correction request and the memory defense request.

6. The memory device of claim 1, wherein the correcting and defending logic circuit generates the gating control signal based on the host correction request, such that the bank gating circuit is coupled to the spare bank instead of a memory bank corresponding to the target of the host correction request.

7. The memory device of claim 1, wherein the correcting and defending logic circuit generates the gating control signal based on the memory defense request, such that the spare bank mirrors a memory bank corresponding to the target of the memory defense request or the memory bank corresponding to the target of the memory defense request is interleaved with the spare bank.

8. The memory device of claim 7, wherein when a write operation is performed on the memory bank corresponding to the target of the memory defense request, the correcting and defending logic circuit generates the gating control signal to couple the bank gating circuit to both of the spare bank and the memory bank corresponding to the target of the memory defense request.

9. The memory device of claim 7, wherein when a plurality of read operations are performed on the memory bank corresponding to the target of the memory defense request, the correcting and defending logic circuit generates the gating control signal to alternately couple the bank gating circuit to the spare bank and the memory bank corresponding to the target of the memory defense request.

10. A memory module comprising:
a plurality of memory devices; and
a correcting and defending logic circuit configured to generate a gating control signal and a backup command signal based on any one of a host correction request and a memory defense request,
wherein each of the memory devices comprises:
a plurality of memory banks;
at least one spare bank; and
a bank gating circuit coupled to the plurality of memory banks and the at least one of spare bank based on the gating control signal.

11. The memory module of claim 10, wherein the host correction request is transmitted to the correcting and defending logic circuit through a system management bus.

12. The memory module of claim 10, wherein the correcting and defending logic circuit generates the memory defense request based on an address signal.

13. The memory module of claim 12, wherein the correcting and defending logic circuit generates the memory defense request when a specific address signal is consecutively inputted by the number of times equal to or more than a threshold value.

14. The memory module of claim 10, wherein the correcting and defending logic circuit generates the backup command signal and the gating control signal, and copies data stored in a memory bank into the spare bank, the memory bank corresponding to the target of the host correction request and the memory defense request.

15. The memory module of claim 10, wherein the correcting and defending logic circuit generates the gating control signal based on the host correction request, such that the bank gating circuit is coupled to the spare bank instead of a memory bank corresponding to the target of the host correction request.

16. The memory module of claim 10, wherein the correcting and defending logic circuit generates the gating control signal such that the spare bank mirrors a memory bank corresponding to the target of the memory defense request or the memory bank corresponding to the target of the memory defense request is interleaved with the spare bank.

17. The memory module of claim 16, wherein when a write operation is performed on the memory bank corresponding to the target of the memory defense request, the correcting and defending logic circuit generates the gating control signal to couple the bank gating circuit to both of the spare bank and the memory bank corresponding to the target of the memory defense request.

18. The memory module of claim 16, wherein when a plurality of read operations are performed on the memory bank corresponding to the target of the memory defense request, the correcting and defending logic circuit generates the gating control signal to alternately couple the bank gating circuit to the spare bank and the memory bank corresponding to the target of the memory defense request.

19. A memory device comprising:
a plurality of memory banks;
at least one spare bank; and
a correcting and defending logic circuit configured to generate a backup command signal to copy data stored in a memory bank having an error therein into a spare bank from the at least one spare bank, and to copy data stored in a memory bank corresponding to a target of a memory defense request into a spare bank from the at least one spare bank.

20. The memory device of claim 19, wherein the memory defense request is generated when a specific address signal has been consecutively inputted by a number of times equal to or more than a threshold value.
